(19) United States
(12) Patent Application Publication
(10) Pub. No.: US 2009/0105939 A1
(43) Pub. Date: Apr. 23, 2009

(54) VEHICLE NAVIGATION SYSTEM WITH OBSTACLE AVOIDANCE

(75) Inventors: Dmitri A. Dolgov, Ann Arbor, MI (US); Sebastian Thrun, Stanford, CA (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 11/876,203

(22) Filed: Oct. 22, 2007

(51) Int. Cl. G01C 21/00; G06F 17/11

(52) U.S. Cl. 701/201

(57) ABSTRACT

A vehicle navigation system through an area having a plurality of objects. A Voronoi decomposition on the area is first constructed having a number of edges surrounding the obstacles. A Voronoi field having a value between zero and an upper limit is calculated for geometric locations within the area such that the field reaches a maximum value within obstacles and a minimum value on the edges. A transversal cost between adjacent locations in the area from the position of the vehicle and toward a destination is calculated in which the transversal cost increases proportionately with the value of the field. A route is then planned from the position of the vehicle to the destination which minimizes the transversal cost.

### BACKGROUND OF THE INVENTION

I. Field of the Invention

The present invention relates generally to a method for vehicle navigation through an area having obstacles with a mechanism for obstacle avoidance.

II. Description of Related Art

There have been previously known navigation systems, primarily for mobile robots, to guide the robot through an area having one or more obstacles. Such previously known systems provide potential fields associated with the various objects to repel the robot away from the object and thus avoid collision. These previously known attempts, however, have not proven wholly satisfactory in operation.

One disadvantage of these previously known navigation systems is that the potential fields were subject to local minima problems that potentially can trap the robot in dead ends as well as make narrow passages untransversable. In still other situations, the robot, or other vehicle such as an automotive vehicle, avoids the obstacle, but comes unacceptably close to the object during its travel.

### SUMMARY OF THE PRESENT INVENTION

The present invention provides a vehicle navigation method for obstacle avoidance which overcomes the above-mentioned disadvantages of the previously known methods.

In brief, the navigation system of the present invention is provided for use with an area having a plurality of obstacles. A Voronoi decomposition is first created of the area so that the Voronoi decomposition includes a plurality of edges surrounding each of the objects in the area. Conventional computational means may be utilized to create the Voronoi decomposition.

A Voronoi field having a value between zero and an upper limit is then calculated for all of the geometric locations within the area. The value of the Voronoi field reaches a maximum value within obstacles contained within the area and a minimum value on the edges of the Voronoi decomposition.

A transversal cost between adjacent locations or grids in the area from the position of the vehicle and toward a destination is than calculated. This transversal cost increases proportionately with the value of the Voronoi field at each adjacent relocation through the area.

A route is then plotted from the position of the vehicle, or an arbitrary position, which minimizes the summation of the transversal cost from the current vehicle position, or arbitrary position, and to the destination.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a Voronoi decomposition illustrating an example of the present invention; and

FIG. 2 is an elevational view of an exemplary Voronoi field.

### DETAILED DESCRIPTION OF A PREFERRED EMBODIMENT OF THE PRESENT INVENTION

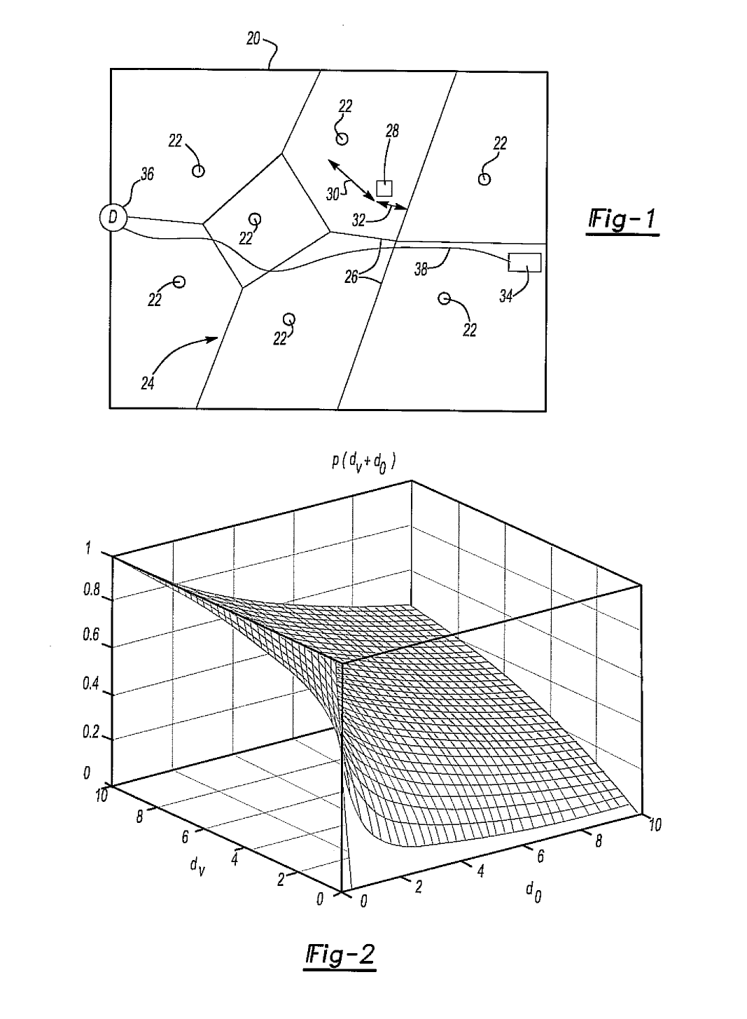

With reference first to FIG. 1, a geometric area 20 is shown having a plurality of obstacles 22. These obstacles together form an obstacle set O.

Still referring to FIG. 1, a Voronoi decomposition 24 is created on the area 20. In creating the Voronoi decomposition 24, a plurality of edges 26 of the Voronoi decomposition are formed wherein each edge 26 is equidistantly spaced from the closest two obstacles 22. These edges 26, furthermore, form a second set V.

After the creation of the Voronoi decomposition, the minimum distance between any geographic position (x, y) may be determined in accordance with the following formula:

$${d}_{O} ( x , y ) = {min}_{( {x}_{O} , {y}_{O} ) ∈ O} {( {( x - {x}_{O} )}^{2} + {( y - {y}_{O} )}^{2} )}^{1 / 2}$$

Consequently, for the arbitrary point 28 in FIG. 1, a minimal distance to the closest obstacle 22 is illustrated at 30.

Similarly, the minimal distance between each point and an edge 26 of the Voronoi decomposition 24 may be determined in accordance with the following formula:

$${d}_{V} ( x , y ) = {min}_{( {x}_{V} , {y}_{V} ) ∈ V} {( {( x - {x}_{V} )}^{2} + {( y - {y}_{V} )}^{2} )}^{1 / 2}$$

Thus, for the arbitrary point 28, the minimum distance between the arbitrary point and an edge 26 of the decomposition 24 is illustrated at 32.

After the minimal distance d_{O} between each geometric location in the area and the closest obstacle 22 has been calculated, as well as the minimum distance d_{V} between each arbitrary geometric location and the nearest edge 26 has been calculated, a Voronoi field may be defined in accordance with the following formula:

$${p}_{V} ( x , y ) = {( \frac{α}{α + {d}_{O} ( x , y )} )}^{β} {( 1 - \frac{{d}_{O}}{{d}_{O} ( x , y ) + {d}_{V} ( x , y )} )}^{γ}$$

where p_{V}=field
α=constant>0
β=constant>0
γ=constant>0

Consequently, as can be seen from the formula for calculating the Voronoi field, the Voronoi field varies in value between zero and an upper limit, illustrated in this example as one. The Voronoi field, furthermore, reaches its maximum of one only within obstacles and, conversely, reaches its minimum of zero only on the edges 26 of the Voronoi decomposition. An exemplary Voronoi field is illustrated in FIG. 2 with the constant α selected to be 100 and the constants β and γ set to 1.

The Voronoi field p_{V} automatically adapts to the geometry of the area 20. More specifically, as the distance d_{O} to the obstacles increases, the field decreases quickly in narrow open regions. Conversely, the field decreases more slowly in regions where the obstacles are far apart. Furthermore, if a global attractive potential is established in the area 20, local minima are avoided between convex objects.

The computation of the Voronoi field p_{V} may be carried out in any conventional fashion. However, a two-phase grid-based brushfire algorithm such as disclosed by Choset, Lynch, Hutchinson, Kantor, Burgard, Kavraki and Thrun (2005) is preferred for computational efficiency.

Following calculation of the Voronoi field within the area 24, a transversal cost between an arbitrary point 34 in the area 20 and a destination 36 in the area is calculated. More specifically, the transversal cost from a grid cell (x₀, y₀, θ₀) where θ represents the direction of travel to an adjacent cell (x₁, y₁, θ₁) is first examined to ensure that the turning radius from one cell to its adjacent cell satisfies the turning radius restraints dθₘₐₓ by performing the following calculation:

$$\frac{\vert {θ}_{0} - {θ}_{1} \vert}{d ( {x}_{0} , {y}_{0} {x}_{1} , {y}_{1} )} \leq d {θ}_{max}$$

If the turning constraints of the vehicle 34 are not met at cell (x₀, y₀) in orientation θ₀ to the adjacent cell (x₁, y₁) with the orientation θ₁, the transversal cost between those two adjacent cells is set to a very high value, such as infinity.

Similarly, if an obstacle 22 is encountered when transversing between adjacent cells, the transversal cost is also set to a very high amount, for example infinity, for those two cells.

Assuming, however, that the turning radius constraints of the vehicle are met and that no obstacle is encountered, the transversal cost Δ (x₀, y₀, θ₁, x₁, y₁, θ₁) is calculated in accordance with the following formula:

$$Δ ( {x}_{0} , {y}_{0} , {θ}_{0} , {x}_{1} , {y}_{1} , {θ}_{1} ) = ( {x}_{0} , {y}_{0} , {x}_{1} , {y}_{1} ) [ 1 + {p}_{V} ( \frac{{x}_{0} + {x}_{1}}{2} , \frac{{y}_{0} + {y}_{1}}{2} ) ]$$

The above transversal costs are calculated for all of the grids within the area 20 from a selected point, such as the position of the vehicle 34, and to the destination 36.

A route 38 from the origin and to the destination is then plotted which minimizes the summation of the transversal cost between those two locations. The plotted route may be used to either direct the operator of the vehicle or to automatically control the operation of the vehicle.

After the route 38 has been plotted, conventional smoothing algorithms may be used on the plotted route.

From the foregoing, it can be seen that the present invention provides a novel vehicle navigation system with obstacle collision avoidance which overcomes the deficiencies of previously known systems. In particular, since the field increases in value as the vehicle nears an obstacle, very near collisions with the obstacles are avoided. Similarly, navigation of the vehicle through even relatively narrow passageways can be accommodated with the method of the present invention.

Having described our invention, however, many modifications thereto will become apparent to those skilled in the art to which it pertains without deviation from the spirit of the invention as defined by the scope of the appended claims.

We claim:

1. A vehicle navigation method through an area having a plurality of obstacles comprising the steps of:
creating a Voronoi decomposition on the area, said decomposition having a plurality of edges,
calculating a Voronoi field having a value between zero and an upper limit for geometric locations within the area such that the field reaches a maximum value within the obstacles and a minimum value on said edges,
calculating a transversal cost between adjacent locations in the area from an origin toward a destination, said transversal cost increasing proportionately with the value of the field,
plotting a route which minimizes the transversal cost to the destination.

2. The invention as defined in claim 1 wherein said cost calculating step further comprises the step of determining whether the orientation of the vehicle between the cells satisfies predetermined vehicle turning ratio constraints and, if not, assigning a high value to the calculated transversal cost.

3. The invention as defined in claim 1 wherein said cost calculating step further comprises the step of assigning a high value to the calculated transversal cost whenever an obstacle is encountered between the adjacent locations.

4. The invention as defined in claim 1 wherein the Voronoi field is defined as follows:
$${p}_{V} ( x , y ) = {( \frac{α}{α + {d}_{O} ( x , y )} )}^{β} {( 1 - \frac{{d}_{O}}{{d}_{O} ( x , y ) + {d}_{V} ( x , y )} )}^{γ}$$
where p_{V}=field
α=constant>0
β=constant>0
γ=constant>0

5. The invention as defined in claim 1 and comprising the further step of smoothing the route.

6. The invention as defined in claim 1 wherein the origin corresponds to the position of the vehicle.
